(19) United States
(12) Patent Application Publication
(10) Pub. No.: US 2015/0096657 A1
(43) Pub. Date: Apr. 9, 2015

(54) PNEUMATIC CONTROL VALVE

(71) Applicant: Eaton Corporation, Cleveland, OH (US)

(72) Inventors: Larry P. Bennett, Bloomfield Hills, MI (US); Lalit M. Patil, Pune (IN)

(21) Appl. No.: 14/570,482

(22) Filed: Dec. 15, 2014

Related U.S. Application Data
(63) Continuation of application No. PCT/US2013/059121, filed on Sep. 11, 2013.

(51) Int. Cl. B60C 23/12

(52) U.S. Cl. CPC B60C 23/12
USPC 152/419; 137/15.19

(57) ABSTRACT

A pneumatic control valve that, when implemented inside a pneumatic tire having an internal reversible peristaltic pump, is configured to prevent air from entering the peristaltic pump if a tire air pressure in a pressurizable cavity of the tire is greater than a selectable set point pressure. The control valve is further configured to open an air passage between an atmosphere external to the tire and an intake of the peristaltic pump if the tire air pressure in the pressurizable cavity of the tire is less than or equal to the selectable set point pressure.

### CROSS-REFERENCE TO RELATED APPLICATIONS

This application is a continuation of International application S.N. PCT/US2013/059121, filed Sep. 11, 2013, which itself claims the benefit of U.S. Provisional Application Ser. No. 61/699,678, filed on Sep. 11, 2012, which is incorporated by reference herein in its entirety.

### BACKGROUND

The present disclosure relates generally to a pneumatic control valve for controlling the tire pressure of a tire having an integral peristaltic pump. A tire with an integral peristaltic pump may include a resilient tubular structure built into the wall of the tire. When the tire rolls, the resilient tubular structure is compressed and pinched closed in a location near where the tire contacts the road. As the tire continues to roll, the pinched portion of the resilient tubular structure progresses along the tubular structure thereby squeezing air out of the pinched portion into the tubular structure ahead of the pinched portion. The air may be discharged into the tire cavity to inflate the tire. Some tires with integral peristaltic pumps are only capable of inflating the tire when they roll in one direction. Since the wheels and tires on one side of a vehicle substantially rotate in the opposite direction to the wheels and tires on the opposite side of the vehicle, the tires having the one-way pumps are not interchangeable from left to right on the vehicle.

### SUMMARY

Examples of the present disclosure include a pneumatic control valve that, when implemented inside a pneumatic tire having an internal reversible peristaltic pump, is configured to prevent air from entering the peristaltic pump if a tire air pressure in a pressurizable cavity of the tire is greater than a selectable set point pressure. The control valve is further configured to open an air passage between an atmosphere external to the tire and an intake of the peristaltic pump if the tire air pressure in the pressurizable cavity of the tire is less than or equal to the selectable set point pressure.

### BRIEF DESCRIPTION OF THE DRAWINGS

Features and advantages of examples of the present disclosure will become apparent by reference to the following detailed description and drawings, in which like reference numerals correspond to the same or similar, though perhaps not identical, components. For the sake of brevity, reference numerals or features having a previously described function may or may not be described in connection with other drawings in which they appear.

FIG. 1 is a semi-schematic view of a pneumatic control valve of an example of the present disclosure depicting the pneumatic control valve in a pressure hold mode;

FIG. 2 is a semi-schematic view of the pneumatic control valve of an example of the present disclosure depicting the pneumatic control valve in counter clockwise tire rotation fill mode;

FIG. 3 is a semi-schematic view of the pneumatic control valve of an example of the present disclosure depicting the pneumatic control valve in clockwise tire rotation fill mode;

FIG. 4 is a cross-sectional view of a wheel and tire depicting two examples of orientations of the pneumatic control valve with respect to the tire according to the present disclosure;

FIG. 5 is a perspective view of an example of the pneumatic control valve according to the present disclosure;

FIG. 6 is a perspective view of another example of the pneumatic control valve according to the present disclosure;

FIG. 7 is a perspective view of a further example of the pneumatic control valve according to the present disclosure;

FIG. 8 depicts three cross-sectional views of the example of the pneumatic control valve depicted in FIG. 5, showing air flow through the valve in a fill mode according to the present disclosure;

FIG. 9 depicts a cross-sectional view of the example of the pneumatic control valve depicted in FIG. 5, showing check valves according to the present disclosure;

FIG. 10 is a cross-sectional perspective view of the example of the pneumatic control valve depicted in FIG. 7 according to the present disclosure;

FIG. 11 is a semi-schematic view of an example of a pneumatic control valve of the present disclosure depicting the pneumatic control valve with header cavities; and

FIG. 12 is a cut-away, cross-sectional view of the example of the pump feed check valves shown in FIG. 9 depicting a relative orientation with respect to an axle axis according to the present disclosure.

### DETAILED DESCRIPTION

The present disclosure relates generally to a pneumatic control valve for controlling the tire pressure of a tire having an integral peristaltic pump. Some land vehicles include a pneumatic tire mounted on a wheel to roll in contact with a ground surface. The tire may form a seal with the rim of the wheel, and substantially contain a gas in a substantially sealed tire cavity defined by the tire and wheel. The gas may be air, nitrogen, another gas or combination of gasses. The gas may be pressurized in the tire thereby inflating the tire. The inflated tire supports and cushions the wheel.

It is to be understood that gage pressure in a tire is the difference between the pressure in the tire and the atmospheric pressure outside the tire. It is to be further understood that tire pressure means the gage pressure of the tire.

If no air is added to some inflated tires, the tires may experience diminishing tire pressure over time. For example, some of the pressurized air substantially contained by the tire may slowly escape by diffusion through the tire wall. Atmospheric pressure and temperature may also influence the tire pressure. A tire will generally perform better when the tire pressure is at a particular design pressure. For example, a vehicle may experience better fuel economy with properly inflated tires compared to the same vehicle operating with underinflated tires.

A tire that includes a peristaltic pump may also be known as a self-inflating tire. As disclosed herein, the peristaltic pump includes a tube integrated into the tire wall. The weight of the vehicle causes the tire to change shape as the tire rolls. For example, the generally round tire may have a contact patch that is compressed to substantially match the road surface. A compressed region of the tire wall near the contact patch may pinch and close the tube integrated into the tire wall. As the tire continues to roll, the pinched portion of the tube progresses along the tube structure, thereby squeezing air out of the pinched portion into the portion of the tube ahead of the pinched portion. The air may be discharged from the tube ultimately into the tire cavity to inflate the tire.

In some self-inflating tires, air is not prevented from entering the peristaltic pump, and a spring operated check valve at a port in the tire cavity sets a minimum pressure that must be achieved by the pump in order to add air to the tire. In such self-inflating tires, the target tire pressure may be limited by a capacity of the peristaltic pump. In other self-inflating tires, air is prevented from entering the inlet of the peristaltic pump after a desired tire pressure is achieved; however, the air from the tire cavity is allowed to recirculate in the peristaltic pump. In some self-inflating tires, only approximately one half of the circumference of the tire is used to compress air in the peristaltic pump for a rotational cycle.

In sharp contrast, in examples of the present disclosure, a pneumatic control valve prevents air from entering the peristaltic pump if a tire air pressure in a pressurizable cavity of the tire is greater than a selectable set point pressure. In examples of the present disclosure, air from the tire cavity is prevented from recirculating in the peristaltic pump and being recompressed. Without being bound to any theory, it is believed that energy may be saved by preventing air from being compressed when additional compressed air is not needed.

Still further, in examples of the present disclosure, most of the circumference of the tire is used by the peristaltic pump for a rotational cycle. The longer peristaltic pump tube allows greater pump capacity compared to self-inflating tires that only use about half of the circumference of the tire in a rotational cycle. The pneumatic control valve of the present disclosure allows the intake and the output of the peristaltic pump to be reversed in response to the rotational direction of the tire. The reversibility of the peristaltic pump due to the connection to the pneumatic control valve disclosed herein allows most of the circumference of the tire to be allocated to a single peristaltic pump, thereby increasing the capacity of the pump. A pump with greater capacity may achieve higher pressures or fill a tire faster than a pump with less capacity.

The mass of air pumped into the tire cavity in a single revolution may be relatively small compared to the mass of air in a fully inflated tire. Since a tire may roll hundreds of revolutions per mile, and many miles per hour, the pumping capacity of a self-inflating tire may be substantial. In examples of the present disclosure, the peristaltic pump may pump from about 0.1 percent to about 5.0 percent of the mass of air into a tire near rated inflation pressure in about one minute.

It is to be understood that an internal peristaltic pump, as used herein, is disposed substantially within the tire or the tire cavity. For example, the internal peristaltic pump may be embedded in a wall of the tire. As such, the word internal refers to a relative position of the peristaltic pump with respect to the tire. Internal means substantially within a volume bounded by the surfaces of the tire and wheel that are in contact with the environment surrounding the tire when the tire is installed on a wheel. An air filter of the internal peristaltic pump may be disposed at the external surface of tire in the present disclosure. A pump that is mounted external to the tire, for example on an axle, or on a vehicle frame member is not an internal peristaltic pump as disclosed herein even if the pump is disposed within a tank or body other than the tire.

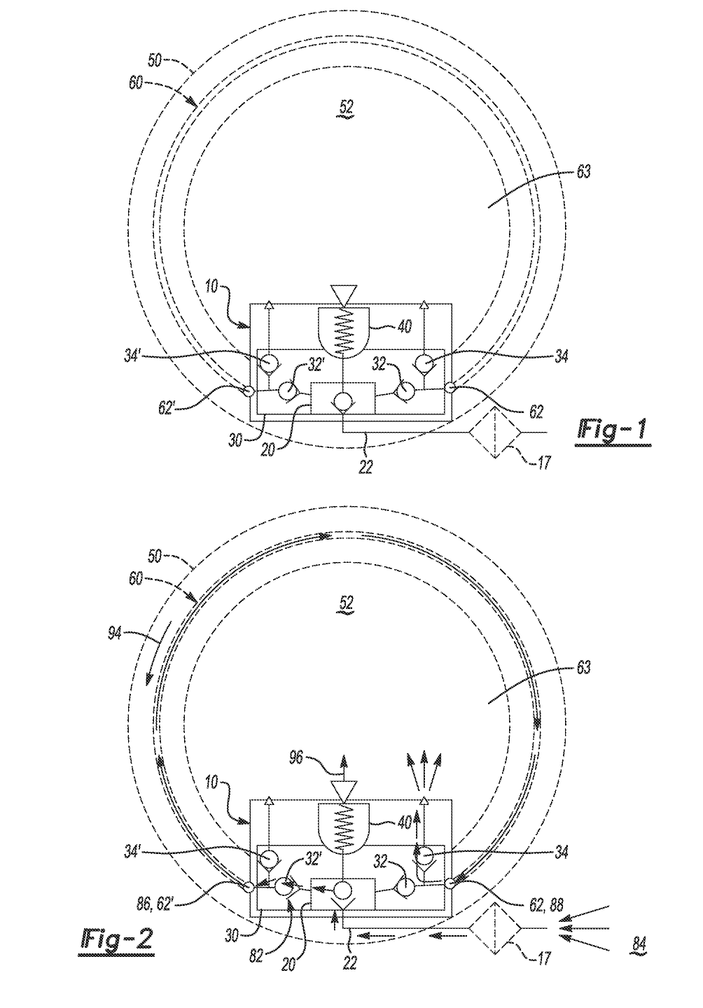

Referring now to FIG. 1, a semi-schematic view of a pneumatic control valve 10 of the present disclosure is depicted. It is noted that FIG. 1 is a semi-schematic representation that shows interconnections of elements of the present disclosure. As such, FIG. 1 does not include the wheel and may not always depict relative placement or size of the elements depicted. A tire 50 and an internal reversible peristaltic pump 60 are represented in hidden line. A pressurizable cavity 52 of the tire 50 is represented as the space in the center of FIG. 1. The pneumatic control valve 10 includes a manifold 20 defined in a valve body 30. A set point valve 40 is in fluid communication with the manifold 20 and with the pressurizable cavity 52 of a tire 50. The set point valve 40 operatively controls air flow between an inlet 22 and the manifold 20. A filter 17 is shown in hidden line in the path of the air flowing through inlet 22. A clockwise rotation pump feed check valve 32 is in fluid communication with the manifold 20 and with a first port 62 of the internal reversible peristaltic pump 60. A counter-clockwise rotation pump feed check valve 32′ is in fluid communication with the manifold 20 and with a second port 62′ of the internal reversible peristaltic pump 60. A first tire pressure check valve 34 is in fluid communication between the pressurizable tire cavity 52 and the first port 62. A second tire pressure check valve 34′ is in fluid communication between the pressurizable tire cavity 52 and the second port 62′.

In FIG. 1, the pneumatic control valve 10 is shown in a pressure hold mode. In the pressure hold mode, air is prevented from entering the reversible peristaltic pump 60 if a tire air pressure 63 in the pressurizable cavity 52 of the tire 50 is greater than a selectable set point pressure. More specifically, in the pressure hold mode, the pneumatic control valve 10 blocks air from entering the manifold 20 via the inlet 22 by operation of the set point valve 40.

FIG. 2 depicts the pneumatic control valve 10 in a counter clockwise tire rotation fill mode. Counter clockwise tire rotation indicator arrow 94 shows that the tire 50 is rotating counter clockwise. The upward-pointing set point state indicator arrow 96 shows that the tire air pressure 63 is less than or equal to the set point pressure. In response to the tire air pressure 63 being less than or equal to the set point pressure, the set point valve 40 opens and allows atmospheric air to enter through the inlet 22 into the manifold 20. Air passes from the manifold 20 through the counter-clockwise rotation pump feed check valve 32′ and through second port 62′ into the peristaltic pump 60. Since the air has not yet been compressed by the peristaltic pump, it will be blocked from passing through the second tire pressure check valve 34′. It is noted that when the tire 50 rotates in the counter clockwise direction, the peristaltic pump compresses the air and moves the compressed air in the clockwise direction. The compressed air exits the peristaltic pump 60 through first port 62 but is prevented from entering into the manifold 20 by clockwise rotation pump feed check valve 32. The compressed air passes through the first tire pressure check valve 34 into the pressurizable tire cavity 52 as long as the compressed air is at a pressure greater than the tire pressure 63.

In FIG. 2, the pneumatic control valve 10 is shown in a counter clockwise tire rotation fill mode. In the counter clockwise tire rotation fill mode, the peristaltic pump 60 opens an air passage 82 between the atmosphere 84 external to the tire 50 and an intake 86 of the peristaltic pump 60 if the tire air pressure 63 in the pressurizable cavity 52 of the tire 50 is less than or equal to the selectable set point pressure. In the example depicted in FIG. 2, the air passage 82 is internal to the valve body 30 and opening the air passage 82 includes opening the set point check valve 40 and the counter-clockwise rotation pump feed check valve 32′. In the counter clockwise tire rotation fill mode, the intake 86 of the reversible peristaltic pump 60 corresponds to the second port 62′, and an output 88 of the reversible peristaltic pump 60 corresponds to the first port 62.

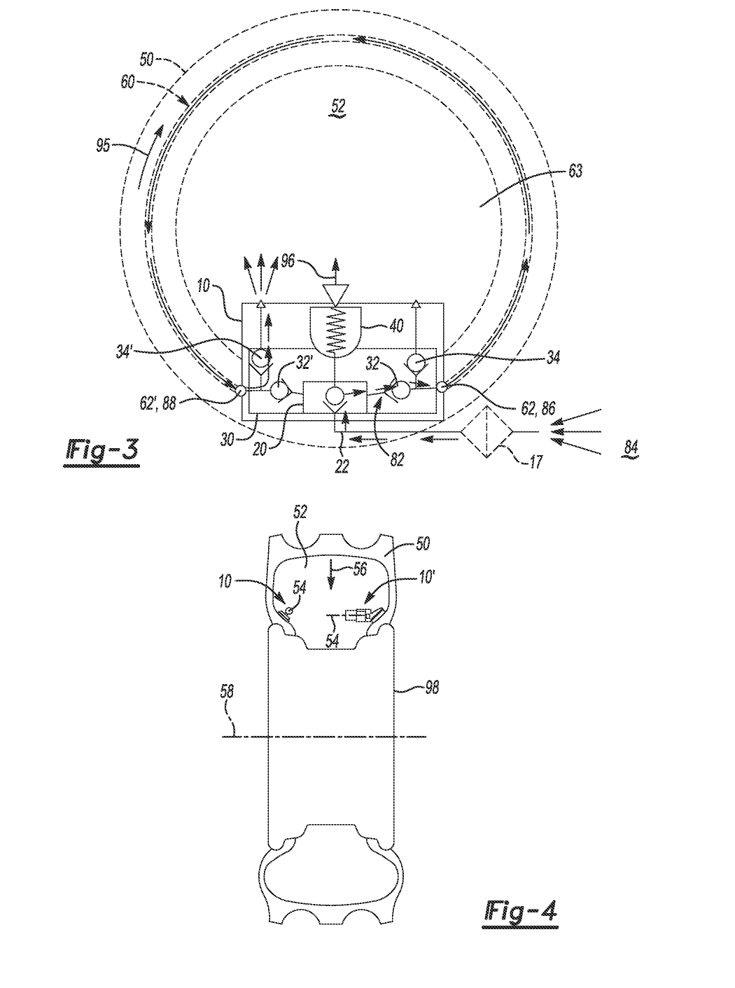

FIG. 3 depicts the pneumatic control valve 10 in a clockwise tire rotation fill mode. Clockwise tire rotation indicator arrow 95 shows that the tire 50 is rotating clockwise. The upward-pointing set point state indicator arrow 96 shows that the tire air pressure 63 is less than or equal to the set point pressure. In response to the tire air pressure 63 being less than or equal to the set point pressure, the set point valve 40 opens and allows atmospheric air to enter through the inlet 22 into the manifold 20. Air passes from the manifold 20 through the clockwise rotation pump feed check valve 32 and through first port 62 into the peristaltic pump 60. Since the air has not yet been compressed by the peristaltic pump 60, it will be blocked from passing through the first tire pressure check valve 34. It is noted that when the tire 50 rotates in the clockwise direction, the peristaltic pump 60 compresses the air and moves the compressed air in the counter clockwise direction. The compressed air exits the peristaltic pump 60 through second port 62′ but is prevented from entering into the manifold 20 by counter clockwise rotation pump feed check valve 32′. The compressed air passes through the second tire pressure check valve 34′ into the pressurizable tire cavity 52 as long as the compressed air is at a pressure greater than the tire pressure 63.

In FIG. 3, the pneumatic control valve 10 is shown in a clockwise tire rotation fill mode. In the clockwise tire rotation fill mode, the peristaltic pump 60 opens an air passage 82 between the atmosphere 84 external to the tire 50 and an intake 86 of the peristaltic pump 60 if the tire air pressure 63 in the pressurizable cavity 52 of the tire 50 is less than or equal to the selectable set point pressure. In the example depicted in FIG. 3, the air passage 82 is internal to the valve body 30 and opening the air passage 82 includes opening the set point check valve 40 and the clockwise rotation pump feed check valve 32. In the clockwise tire rotation fill mode, the intake 86 of the reversible peristaltic pump 60 corresponds to the first port 62 and an output 88 of the reversible peristaltic pump 60 corresponds to the second port 62′.

Since the intake 86 and the output 88 of the peristaltic pump 60 can be reversed depending on the direction of rotation of the tire, the peristaltic pump 60 is reversible. It is to be understood that the reversible pump 60 and pneumatic control valve 10 are connected to fill the tire. The reversibility of the pump 60 refers to the direction of rotation of the tire 50, and does not mean that air may be pumped out of the tire.

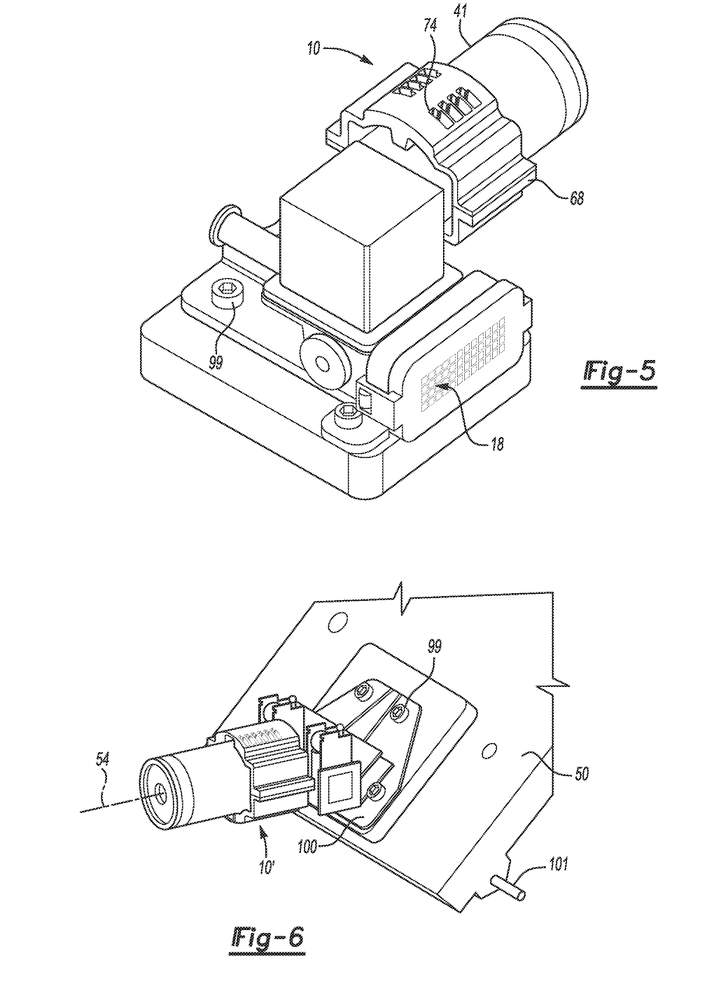

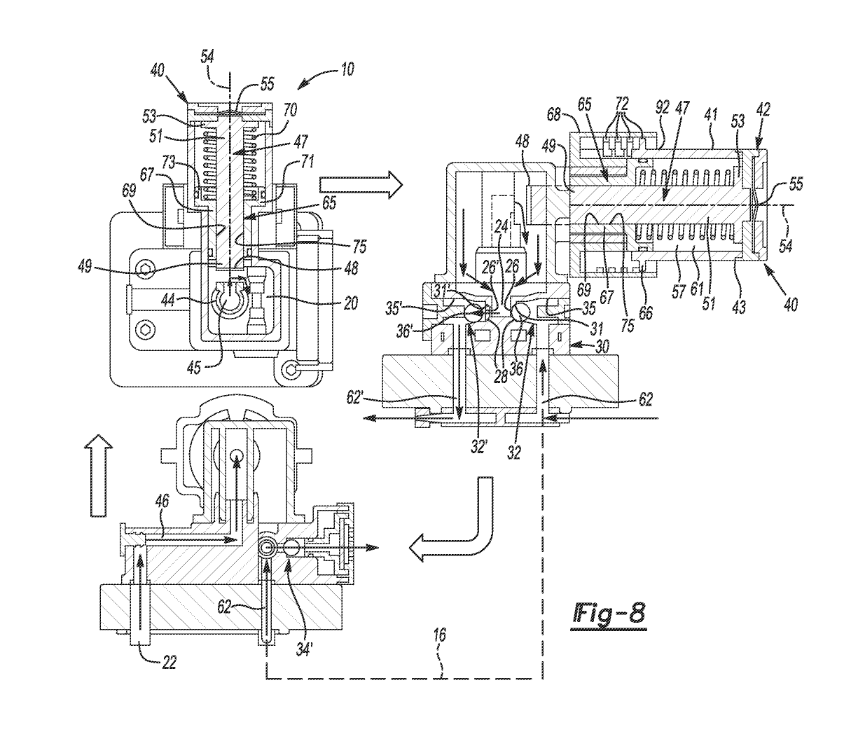

FIG. 4 is a cross-sectional view of a wheel 98 and tire 50 depicting two examples of orientations of the pneumatic control valve 10, 10′ with respect to the tire 50 according to the present disclosure. The pneumatic control valve 10, 10′ is fixedly attached to the tire 50 and at least a portion of the pneumatic control valve 10, 10′ is disposed within the pressurizable tire cavity 52. It is to be understood that both pneumatic control valves 10, 10′ are shown in the same drawing FIG. 4 for convenience; however, disposing two pneumatic control valves at the same time is not a requirement of the present disclosure. The pneumatic control valve 10, 10′ is depicted with a cylindrical axis 54 of the valve stem 51 (see FIG. 8) substantially orthogonal to a centripetal acceleration 56 associated with rotation of the tire 50 about an axle axis 58. Without being held to any theory, orienting the cylindrical axis 54 of the valve stem 51 orthogonal to the centripetal acceleration 56 substantially prevents the centripetal acceleration 56 from substantially changing the set point pressure. FIG. 5 is a perspective view of an example of the pneumatic control valve 10 according to the present disclosure. A locking collar 68 is shown mounted around cylinder 41. Windows 74 are shown in the locking collar 68. The windows 74 allow visual confirmation of a position of a locking flange 66 (see FIG. 8) in an adjustment slot 72 (see FIG. 8). The position of the locking flange 66 in the adjustment slots 72 indicates a biasing preload and corresponding set point pressure. An outlet screen 18 is depicted in FIG. 5. Air from the peristaltic pump 60 is ultimately discharged through the outlet screen 18. The outlet screen 18 substantially prevents foreign matter that may be in the pressurizable tire cavity 52 (see FIG. 4) from fouling the pneumatic control valve 10.

FIG. 6 is a perspective view of another example of the pneumatic control valve 10′ according to the present disclosure. As depicted in FIG. 4, an angle between base 100 and the cylindrical axis 54 mounts the cylindrical axis 54 as depicted in FIG. 4 to substantially prevent the centripetal acceleration 56 (see FIG. 4) from effectively changing the set point pressure. FIG. 6 also depicts a peristaltic pump tube 101 embedded in the wall of the tire 50.

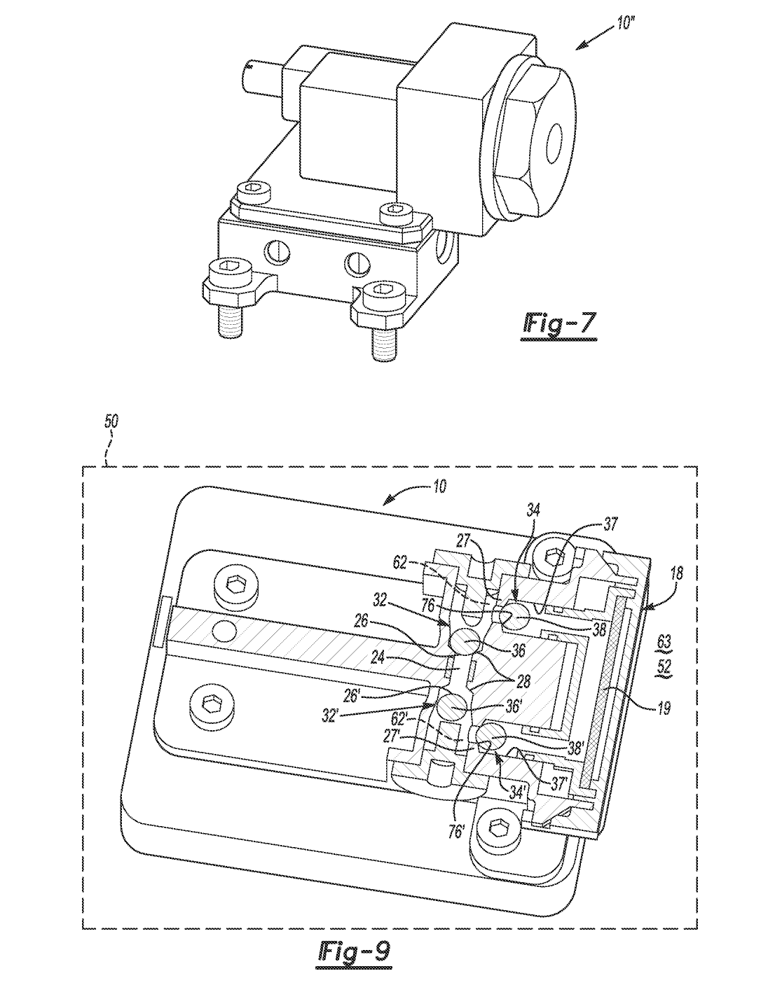

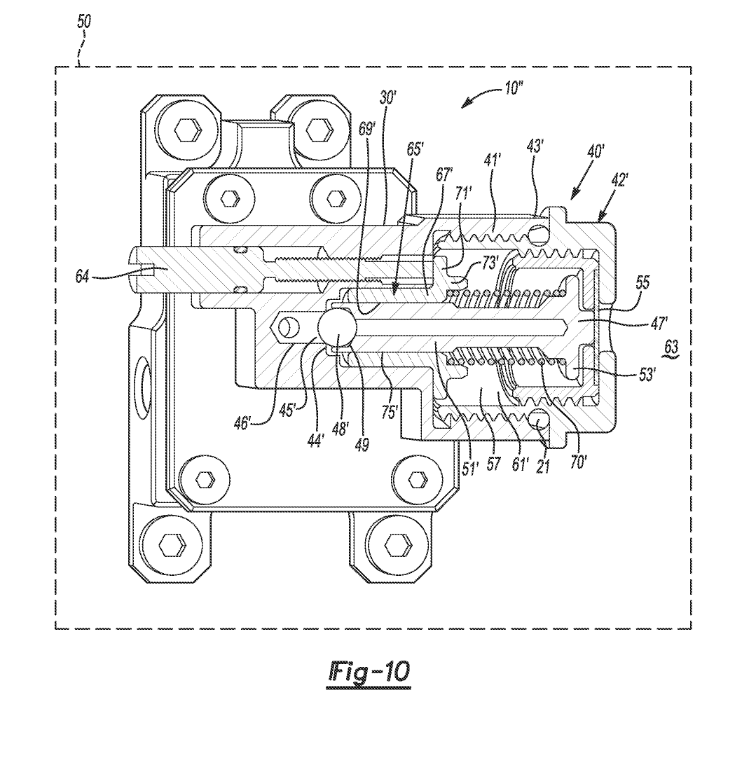

FIG. 7 is a perspective view of a further example of the pneumatic control valve 10″ according to the present disclosure. The pneumatic control valve 10″ does not have a locking collar 68 as shown in FIG. 5. In the pneumatic control valve 10″, selective adjustment of the set point pressure is accomplished by turning a set point adjustment screw 64. Further details of the adjustment mechanism are included below with the discussion of FIG. 10.

Although allen head cap screws are shown as fasteners in FIGS. 5, 6 and 7, it is to be understood that other types of fasteners may be used to secure the pneumatic control valve 10, 10′, 10″ to the tire 50. For example, screw fasteners including hex head bolts, pan head screws, countersink screws, etc., with Phillips drive, torx drive, slot drive, etc. may be used in place of or in combination with the allen head cap screws depicted in FIG. 5. Further, rivets and other non-removable fasteners may be used in place of the allen head cap screws depicted in FIGS. 5, 6 and 7. Still further, welding, adhesives, overmolding and encapsulation with rubber from the tire 50 may be used in place of the allen head cap screws depicted in FIGS. 5, 6 and 7.

FIG. 8 depicts three cross-sectional views of the example of the pneumatic control valve 10 depicted in FIG. 5 showing air flow through the valve in a fill mode according to the present disclosure. The pneumatic control valve 10 includes a manifold 20 defined in a valve body 30.

A set point valve 40 is in fluid communication with the manifold 20 and with a pressurizable cavity 52 of a tire 50 (see FIG. 2). The set point valve 40 operatively controls air flow between an inlet 22 and the manifold 20. Set point valve 40 includes a cylinder 41 and a cylinder head 42 disposed in sealing engagement with an end 43 of the cylinder 41. The set point valve 40 also includes an annular poppet valve seat 44 defining an orifice 45 in a conduit 46 in fluid connection with the inlet 22. A poppet valve 47 has a valve face 48 disposed at an end 49 of a substantially cylindrical valve stem 51. The poppet valve 47 further has an actuator flange 53 disposed on the valve stem 51 opposite to the valve face 48. The valve face 48 is selectively sealingly engageable with the poppet valve seat 44. The set point valve 40 has an annular valve stem guide 65 including a barrel 67 defining a bore 69 and an annular spring retention flange 71 disposed at a spring end 73 of the barrel 67. The valve stem guide 65 is disposed in the cylinder 41 and slidingly engaged with the valve stem 51 in the bore 69. The valve stem guide 65 includes a fluid conduit 75 to equalize pressure between the manifold 20 and the cylinder 41.

Still referring to FIG. 8, and in particular referring to the set point valve 40, a biasing spring 70 is disposed between the spring retention flange 71 and the actuator flange 53 to urge the poppet valve 47 open with a biasing preload. The biasing preload corresponds to the set point pressure. The valve face 48 sealingly engages the poppet valve seat 44 if the tire air pressure 63 is greater than or equal to the set point pressure.

The set point valve 40 still further includes a resilient diaphragm 55 operatively disposed in sealing engagement with the cylinder head 42. The diaphragm 55 sealingly separates a cylinder volume 57 from the pressurizable tire cavity 52 and applies a closing force on the valve stem 51 in response to a pressure difference between a cylinder pressure 61 and a tire air pressure 63 in the pressurizable tire cavity 52. A “closing force” means a force in a direction toward closing the set point valve 40. A closing force does not necessarily mean that the force is sufficient to overcome other forces acting on the valve stem 51. Similarly, an “opening force” means a force in a direction toward opening the set point valve 40 and not necessarily a force sufficient to overcome other forces acting on the valve stem 51.

Although FIG. 8 depicts the pneumatic control valve 10 in the fill mode rather than the pressure hold mode, it is to be understood that the set point valve 40 compensates for changes in the cylinder pressure 61 that may occur from vacuum generated at the intake 86 (see FIG. 2 and FIG. 3) by the peristaltic pump 60 when the pneumatic control valve 10 is in the pressure hold mode (see FIG. 1). For example, if the pneumatic control valve 10 is in the pressure hold mode, the peristaltic pump 60 may draw a vacuum in the manifold 20. Since the manifold 20 is in fluid communication with the cylinder 41 via fluid conduit 75, in the example, the vacuum in the manifold 20 is communicated to the cylinder 41 and reduces the cylinder pressure 61 accordingly. Since there is compensation for vacuum in the cylinder 41, the set point valve 40 closes when the tire air pressure 63 is greater than or equal to the set point pressure.

The compensation for vacuum in the cylinder 41 is accomplished in the example of the pneumatic control valve 10 shown in FIG. 8 by having a seat effective area of the orifice 45 defined by the annular poppet valve seat 44 substantially equal to a diaphragm effective area of the diaphragm 55. The seat effective area means the area upon which a pressure difference between the atmospheric pressure and the cylinder pressure 61 acts to produce an opening force on the valve stem 51. The diaphragm effective area means the area upon which another pressure difference between the tire air pressure 63 and the cylinder pressure 61 acts to produce a closing force on the valve stem 51. Recall that the tire air pressure 63 is relative to the atmospheric pressure outside the tire. Since the seat effective area and the diaphragm effective area are substantially equal, variation in the cylinder pressure 61 relative to atmospheric pressure will produce equal forces acting in opposite directions on the valve stem 51.

In the example depicted in FIG. 8, the biasing preload is selectable to select a set point pressure. The set point valve 40 includes a locking flange 66 circumscribing an external surface 92 of the cylinder 41. A locking collar 68 has a plurality of adjustment slots 72 to selectively engage the locking flange 66 to retain the cylinder 41 in one of a plurality of adjustment positions. The biasing preload and the corresponding set point pressure are set by selecting the adjustment slot 72 in which the locking flange 66 is engaged. As shown in FIG. 5, the locking flange 66 is visible through a window 74 in the locking collar 68 to provide visible confirmation of the selected biasing preload and corresponding set point pressure.

A clockwise rotation pump feed check valve 32 is in fluid communication with the manifold 20 and with a first port 62 of the reversible peristaltic pump 60. In the fill mode depicted in FIG. 8, the clockwise rotation pump feed check valve 32 operatively prevents air from flowing from the manifold 20 to the first port 62. The clockwise rotation pump feed check valve 32 includes a check valve bore 35 defined in the valve body 30. The check valve bore 35 is in fluid communication with the manifold 20 and the first port 62. A ball valve seat 31 is defined at a manifold end 28 of the check valve bore 35. The ball valve seat 31 circumscribes an aperture 26 in a passageway 24 to the manifold 20. A pump feed check valve ball 36 is operatively disposed in the check valve bore 35. The pump feed check valve ball 36 operatively engages the ball valve seat 31 to substantially prevent fluid flow from the first port 62 to the manifold 20.

In the fill mode shown in FIG. 8, a counter-clockwise rotation pump feed check valve 32′ opens to allow air to flow from the manifold 20 to the second port 62′. A first tire pressure check valve 34 is in fluid communication between the pressurizable tire cavity 52 and the first port 62 (see also FIG. 9). The first tire pressure check valve 34 substantially prevents air that is in the pressurizable tire cavity 52 from flowing out of the pressurizable tire cavity 52 through the first port 62. The first tire pressure check valve 34 allows compressed air from the peristaltic pump 60 to flow into the pressurizable tire cavity if the pressure in the first port 62 is greater than the tire pressure 63.

It is to be understood that the dashed line indicated by reference numeral 16 depicts that the section shown in the lower left view of FIG. 8 is taken through the first port 62.

Still referring to FIG. 8, the counter-clockwise rotation pump feed check valve 32′ is in fluid communication with the manifold 20 and with a second port 62′ of the reversible peristaltic pump 60. In the fill mode depicted in FIG. 8, the counter-clockwise rotation pump feed check valve 32′ operatively allows air to flow from the manifold 20 to the second port 62′. The counter-clockwise rotation pump feed check valve 32′ includes a check valve bore 35′ defined in the valve body 30. The check valve bore 35′ is in fluid communication with the manifold 20 and the second port 62′. A ball valve seat 31′ is defined at a manifold end 28 of the check valve bore 35′. The ball valve seat 31′ circumscribes an aperture 26′ in the passageway 24 to the manifold 20. A pump feed check valve ball 36′ is operatively disposed in the check valve bore 35′. In the fill mode depicted in FIG. 8, the pump feed check valve ball 36′ operatively disengages the ball valve seat 31′ to allow fluid flow from the manifold 20 to the second port 62′. If the air pressure in the second port 62′ is higher than the air pressure in the manifold 20, the pump feed check valve ball 36′ operatively engages the ball valve seat 31′ to prevent fluid flow from the second port 62′ to the manifold 20.

A second tire pressure check valve 34′ is in fluid communication between the pressurizable tire cavity 52 and the second port 62′ (see also FIG. 9). The second tire pressure check valve 34′ substantially prevents air that is in the pressurizable tire cavity 52 from flowing out of the pressurizable tire cavity 52 through the second port 62′. The second tire pressure check valve 34′ allows compressed air from the second port 62′ to flow into the pressurizable tire cavity if the pressure in the second port 62′ is greater than the tire pressure 63.

FIG. 9 depicts a cross-sectional view of the pneumatic control valve 10 depicted in FIG. 5 showing check valves according to an example of the present disclosure. The clockwise pump feed check valve 32 and the counter-clockwise pump feed check valve 32′ have been described above in the description of FIG. 8. FIG. 9 depicts an enlarged view including the first tire pressure check valve 34 and the second tire pressure check valve 34′. The structure of the first tire pressure check valve 34 is similar to the second tire pressure check valve 34′.

In the present disclosure, features and components associated with the first tire pressure check valve and the second tire pressure check valve have a common reference numeral with the features and components associated with the second tire pressure check valve indicated by a prime (′) added to the reference numeral. A tire pressure check valve bore 37, 37′ is defined in the valve body 30, and the tire pressure check valve bore 37, 37′ is in fluid communication with the pressurizable tire cavity 52 and the respective first port 62 or second port 62′. A check valve seat 76, 76′ is defined at a pump port end 27, 27′ of the tire pressure check valve bore 37, 37′. The check valve seat 76, 76′ circumscribes a conduit leading to the respective first port 62 or second port 62′. The reference numeral indicator lines for the first port 62 is and second port 62′ are shown in FIG. 9 in hidden line to indicate that the ports 62, 62′ are in fluid connection to the indicated location.

However, the ports 62, 62′ are not actually visible in FIG. 9. See FIG. 8 for a view of the first port 62 and the second port 62′ in the example of the present disclosure shown in FIGS. 5, 8 and 9. A tire pressure check valve ball 38, 38′ is operatively disposed in the tire pressure check valve bore 37, 37′. The tire pressure check valve ball 38, 38′ operatively engages the check valve seat 76, 76′ to substantially prevent fluid flow from the pressurizable tire cavity 52 to the respective first 62 or second port 62′ in response to a pressure difference across the first tire pressure check valve 34 and the second tire pressure check valve 34′. The tire pressure check valve ball 38, 38′ operatively disengages the check valve seat 76, 76′ to open the respective first 34 or second tire pressure check valve 34′ for fluid flow from the respective first port 62 or second port 62′ to the pressurizable tire cavity 52 in response to a pressure difference across the respective first tire pressure check valve 34 or the second tire pressure check valve 34′. For example, the first tire pressure check valve 34 allows compressed air from the peristaltic pump 60 to flow into the pressurizable tire cavity if the pressure in the first port 62 is greater than the tire pressure 63.

For example, the tire pressure check valve ball 38 operatively engages the check valve seat 76 when the tire pressure 63 in the pressurizable tire cavity 52 is greater than the pressure in the first port 62. Conversely, if the tire pressure 63 in the pressurizable tire cavity 52 is less than the pressure in the first port, the tire pressure check valve ball 38 operatively disengages the check valve seat 76 and allows air to flow from the first port 62 into the tire cavity 52. As shown in FIG. 9, an outlet screen 18 may be included in the air path between first tire pressure check valve 34 or the second tire pressure check valve 34′ and the pressurizable tire cavity 52. The outlet screen may include a screen member 19 that is a piece of filter media. The filter media may be, for example, a porous solid or foam, or a woven or non-woven fiber mesh to allow air to pass through the screen member 19 substantially without restriction while keeping particulate matter in the tire cavity 52 from fouling the pneumatic control valve 10.

FIG. 10 is a cross-sectional perspective view of the example of the pneumatic control valve 10″ depicted in FIG. 7 according to the present disclosure. The pneumatic control valve 10″ is similar to the pneumatic control valve 10 except the set point valve 40′ is structurally different to allow adjustability of the set point pressure by a pressure adjustment screw 64 rather than by using the locking flange 66 and locking collar 68 in the pneumatic control valve 10.

A set point valve 40′ is in fluid communication with the manifold 20 (see, e.g., FIG. 8) and with a pressurizable cavity 52 of a tire 50 (see FIG. 2). The set point valve 40′ includes a cylinder 41′ and a cylinder head 42′ is threadingly disposed in sealing engagement with an end 43′ of the cylinder 41′. As depicted in FIG. 10, a head seal 21 may be sealingly disposed between the cylinder head 42′ and the cylinder 41′. The set point valve 40′ also includes an annular poppet valve seat 44′ defining an orifice 45′ in a conduit 46′ in fluid connection with the inlet 22 (not shown). A poppet valve 47′ has a substantially spherical valve face 48′ disposed at an end 49 of a substantially cylindrical valve stem 51′. The poppet valve 47′ further has an actuator flange 53′ disposed on the valve stem 51′ opposite to the substantially spherical valve face 48′. The substantially spherical valve face 48′ is selectively sealingly engageable with the poppet valve seat 44′. The set point valve 40′ has an annular valve stem guide 65′ including a barrel 67′ defining a bore 69′ and an annular spring retention flange 71′ disposed at a spring end 73′ of the barrel 67′. The valve stem guide 65′ is disposed in the cylinder 41′ and slidingly engaged with the valve stem 51′ in the bore 69′. The valve stem guide 65′ including a fluid conduit 75′ to equalize pressure between the manifold 20 and the cylinder 41′.

Still referring to FIG. 10, and in particular referring to the set point valve 40′, a biasing spring 70′ is disposed between the spring retention flange 71′ and the actuator flange 53′ to urge the poppet valve 47′ open with a biasing preload. The biasing preload corresponds to the set point pressure. The substantially spherical valve face 48′ sealingly engages the poppet valve seat 44′ if the tire air pressure 63 is greater than or equal to the set point pressure.

Similarly to set point valve 40 discussed above, set point valve 40′ compensates for changes in the cylinder pressure 61 that may occur from vacuum generated at the intake 86 (see FIG. 2 and FIG. 3) by the peristaltic pump 60 when the pneumatic control valve 10″ is in the pressure hold mode (see FIG. 1).

The compensation for vacuum in the cylinder 41′ is accomplished in the example of the pneumatic control valve 10″ shown in FIG. 10 by having a seat effective area of the orifice 45′ defined by the annular poppet valve seat 44′ substantially equal to a diaphragm effective area of the diaphragm 55. The seat effective area means the area upon which a pressure difference between the atmospheric pressure and the cylinder pressure 61′ acts to produce an opening force on the valve stem 51′. The diaphragm effective area means the area upon which another pressure difference between the tire air pressure 63 and the cylinder pressure 61′ acts to produce a closing force on the valve stem 51′. Recall that the tire air pressure 63 is relative to the atmospheric pressure outside the tire. Since the seat effective area and the diaphragm effective area are substantially equal, variation in the cylinder pressure 61′ relative to atmospheric pressure will produce equal forces acting in opposite directions on the valve stem 51′.

In the example depicted in FIG. 10, the biasing preload is selectable to select a set point pressure. The set point valve 40′ includes a set point adjustment screw 64 threadingly engaged with valve body 30′ to operatively engage the spring retention flange 71′ to selectively adjust the biasing preload. The biasing preload and the corresponding set point pressure are set by turning the adjustment screw 64. As the adjustment screw 64 advances, the biasing preload on the biasing spring 70′ is increased thereby requiring a greater tire pressure 63 to close the set point valve 40′.

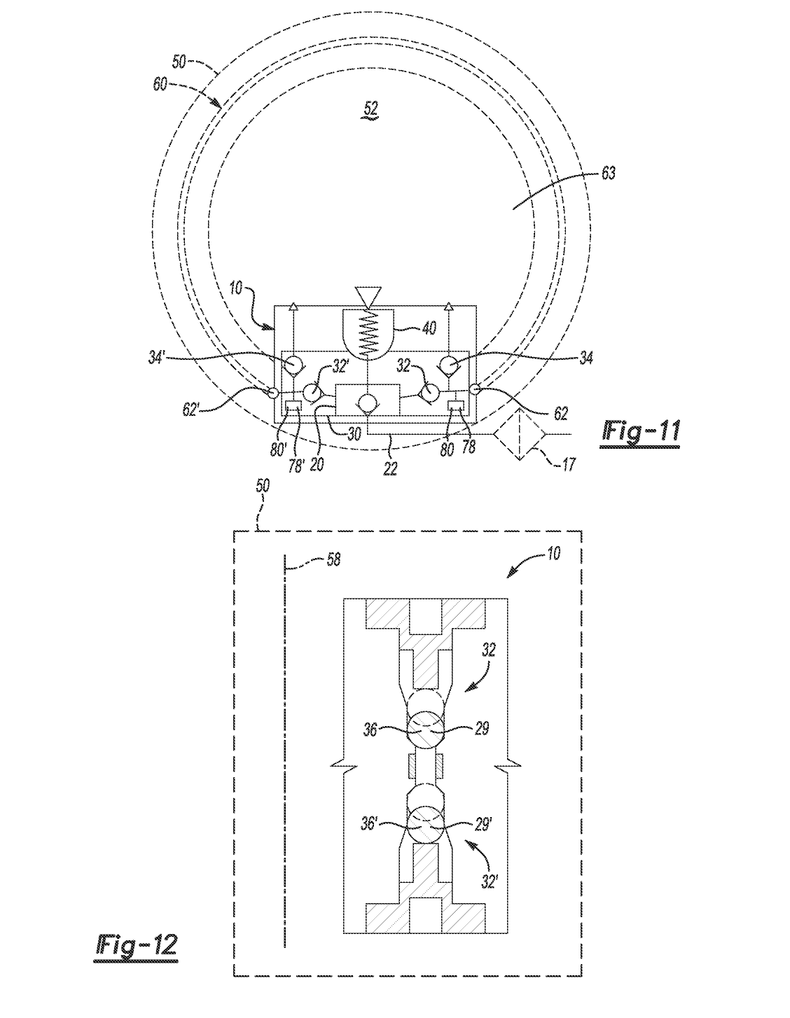

FIG. 11 is a semi-schematic view of a pneumatic control valve 10 of the present disclosure. FIG. 11 is similar to FIG. 1, with some additional elements. A first header cavity 78 is shown in fluid communication with the first port 62. The first header cavity 78 includes a first selectable volume 80 to selectively limit a first maximum pressure attainable by the reversible peristaltic pump 60. A second header cavity 78′ is shown in fluid communication with the second port 62′. The second header cavity 78′ includes a second selectable volume 80′ to selectively limit a second maximum pressure attainable by the reversible peristaltic pump 60. It is to be understood that the first selectable volume 80 and the second selectable volume 80′ may be selected to have the same volume or different volumes.

By establishing the first header cavity 78 and the second header cavity 78′ in fluid communication with the output 88 (see FIG. 2 and FIG. 3) of the peristaltic pump 60 to select a maximum compression ratio of the peristaltic pump 60, a limit is established on the maximum pressure attainable by the peristaltic pump 60.

It is to be understood that the compression ratio of the peristaltic pump 60 is a dimensionless number that is a quotient of a pressure at the output 88 of the peristaltic pump 60 divided by a pressure at the intake 86 for a cycle of the peristaltic pump 60. For example, if the pressure at the intake 86 is 1 bar, and the peristaltic pump 60 compresses the air to a pressure of 20 bar at the output 88, then the compression ratio is 20. The maximum compression ratio is a greatest compression ratio theoretically achievable by the peristaltic pump. Since the first tire pressure check valve 34 or the second tire pressure check valve 34′ may open and release air from the peristaltic pump 60 into the pressurizable tire cavity 52, the compression ratio may be limited to less than the maximum compression ratio in a normally operating system.

FIG. 12 is a cut-away, cross-sectional view of the example of the pump feed check valves 32, 32′ shown in FIG. 9. FIG. 12 depicts a relative orientation with respect to the axle axis 58 according to the present disclosure. A portion of the pneumatic control valve 10 is depicted with respective translatable members 29, 29′ of each pump feed check valve 32, 32′ disposed to translate substantially parallel to the axle axis 58 associated with the tire 50. In an example of the present disclosure, the translatable member may be the pump feed check valve ball 36, 36′.

It is to be understood use of the words “a” and “an” and other singular referents may include plural as well, both in the specification and claims, unless the context clearly indicates otherwise.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

Further, it is to be understood that the terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

Still further, it is to be understood that the ranges provided herein include the stated range and any value or sub-range within the stated range. For example, a percentage ranging from about 0.1 percent to about 5.0 percent should be interpreted to include not only the explicitly recited limits of 0.1 percent to 5.0 percent, but also to include individual amounts, such as 0.5 percent, 1.0 percent, etc., and sub-ranges, such as from about 0.6 percent to about 3.5 percent, etc. Furthermore, when “about” is utilized to describe a value, this is meant to encompass minor variations (±10% from the stated value (e.g., about 1.0 percent is 0.9 percent to 1.1 percent)).

While several examples have been described in detail, it will be apparent to those skilled in the art that the disclosed examples may be modified. Therefore, the foregoing description is to be considered non-limiting.

What is claimed is:

1. A pneumatic control valve, comprising:
a manifold defined in a valve body;
a set point valve in fluid communication with the manifold and with a pressurizable cavity of a tire, the set point valve to operatively control air flow between an inlet and the manifold;
a clockwise rotation pump feed check valve in fluid communication with the manifold and with a first port of a reversible peristaltic pump;
a counter-clockwise rotation pump feed check valve in fluid communication with the manifold and with a second port of the reversible peristaltic pump;
a first tire pressure check valve in fluid communication between the pressurizable tire cavity and the first port; and
a second tire pressure check valve in fluid communication between the pressurizable tire cavity and the second port.

2. The pneumatic control valve as defined in claim 1 wherein the pneumatic control valve is to be fixedly attached to the tire and at least a portion of the pneumatic control valve is to be disposed within the pressurizable tire cavity.

3. The pneumatic control valve as defined in claim 1 wherein the set point valve comprises:
a cylinder;
a cylinder head disposed in sealing engagement with an end of the cylinder;
an annular poppet valve seat defining an orifice in a conduit in fluid connection with the inlet;
a poppet valve having a poppet disposed at an end of a substantially cylindrical valve stem and having an actuator flange disposed on the valve stem opposite to the poppet, wherein the poppet is selectively sealingly engageable with the poppet valve seat; and
a resilient diaphragm operatively disposed in sealing engagement with the cylinder head, the diaphragm to sealingly separate a cylinder volume from the pressurizable tire cavity and to apply a closing force on the valve stem in response to a pressure difference between a cylinder pressure and a tire air pressure in the pressurizable tire cavity.

4. The pneumatic control valve as defined in claim 3 wherein the set point valve further comprises:
an annular valve stem guide including a barrel defining a bore and an annular spring retention flange disposed at a spring end of the barrel, the valve stem guide disposed in the cylinder and slidingly engaged with the valve stem guide in the bore, the valve stem guide including a fluid conduit to equalize pressure between the manifold and the cylinder; and
a biasing spring disposed between the spring retention flange and the actuator flange to urge the poppet valve open with a biasing preload, wherein the biasing preload corresponds to a set point pressure, the poppet to sealingly engage the poppet valve seat if the tire air pressure is greater than or equal to the set point pressure.

5. The pneumatic control valve as defined in claim 4 wherein the biasing preload is selectable to select the set point pressure.

6. The pneumatic control valve as defined in claim 3 wherein a seat effective area of the orifice defined by the annular poppet valve seat is substantially equal to a diaphragm effective area of the diaphragm to compensate for a change in the cylinder pressure from vacuum generated by the peristaltic pump when the pneumatic control valve is in a pressure hold mode.

7. The pneumatic control valve as defined in claim 4 wherein the set point valve further comprises a set point adjustment screw threadingly engaged with the valve body to operatively engage the spring retention flange to selectively adjust the biasing preload.

8. The pneumatic control valve as defined in claim 4 wherein the set point valve further comprises:
a locking flange circumscribing an external surface of the cylinder; and
a locking collar having a plurality of adjustment slots to selectively engage the locking flange to retain the cylinder in one of a plurality of adjustment positions to select the biasing preload and the corresponding set point pressure, wherein the locking flange is visible through a window in the locking collar.

9. The pneumatic control valve as defined in claim 1 wherein the clockwise rotation pump feed check valve and the counter-clockwise rotation pump feed check valve each comprise:
a check valve bore defined in the valve body, the check valve bore in fluid communication with the manifold and the respective first or second port;
a ball valve seat defined at a manifold end of the check valve bore, the ball valve seat circumscribing an aperture in a passageway to the manifold; and
a pump feed check valve ball operatively disposed in the check valve bore, the pump feed check valve ball to operatively engage the ball valve seat to substantially prevent fluid flow from the respective first port or second port to the manifold and to open the respective first port or second port for flow from the manifold to the respective first port or second port.

10. The pneumatic control valve as defined in claim 1 wherein a respective translatable member of each pump feed check valve is to translate substantially parallel to an axle axis associated with the tire.

11. The pneumatic control valve as defined in claim 1 wherein the first tire pressure check valve and the second tire pressure check valve each comprise:
a tire pressure check valve bore defined in the valve body, the tire pressure check valve bore in fluid communication with the pressurizable tire cavity and the respective first or second port;
a check valve seat defined at a pump port end of the tire pressure check valve bore, the check valve seat circumscribing the respective first or second port; and
a tire pressure check valve ball operatively disposed in the tire pressure check valve bore, the tire pressure check valve ball to operatively engage the check valve seat to substantially prevent fluid flow from the pressurizable tire cavity to the respective first or second port and to open the respective first or second tire pressure check valve for fluid flow from the respective first or second port to the pressurizable tire cavity.

12. The pneumatic control valve as defined in claim 1, further comprising:
a first header cavity in fluid communication with the first port wherein the first header cavity includes a first selectable volume to selectively limit a first maximum pressure attainable by the reversible peristaltic pump; and
a second header cavity in fluid communication with the second port wherein the second header cavity includes a second selectable volume to selectively limit a second maximum pressure attainable by the reversible peristaltic pump.

13. A pneumatic control valve that, when implemented inside a pneumatic tire having an internal reversible peristaltic pump, is configured to:
prevent air from entering the peristaltic pump if a tire air pressure in a pressurizable cavity of the tire is greater than a selectable set point pressure; and
open an air passage between an atmosphere external to the tire and an intake of the peristaltic pump if the tire air pressure in the pressurizable cavity of the tire is less than or equal to the selectable set point pressure.

14. The pneumatic control valve as defined in claim 13 wherein:
if the tire is rolling in a first direction, a first port of the peristaltic pump is the intake and a second port is an output of the peristaltic pump; and
if the tire is rolling in a second direction opposite to the first direction, the first port is the output of the peristaltic pump and the second port is the intake of the peristaltic pump.

15. The pneumatic control valve as defined in claim 13, further configured to substantially prevent air from flowing out of the pressurizable tire cavity through the pneumatic control valve to the atmosphere external to the tire.

16. The pneumatic control valve as defined in claim 13, further configured to limit a maximum pressure attainable by the peristaltic pump by establishing a header cavity in fluid communication with an output of the peristaltic pump to select a maximum compression ratio of the peristaltic pump.

17. A method of making a pneumatic control valve, comprising:
defining a manifold in a valve body;
disposing a set point valve in fluid communication with the manifold and to connect in fluid communication with a pressurizable cavity of a tire, the set point valve to operatively control air flow between an inlet and the manifold;
disposing a clockwise rotation pump feed check valve in fluid communication with the manifold and with a first port to connect to a reversible peristaltic pump;
disposing a counter-clockwise rotation pump feed check valve in fluid communication with the manifold and with a second port to connect to the reversible peristaltic pump;
disposing a first tire pressure check valve to connect in fluid communication with the pressurizable tire cavity and the first port; and
disposing a second tire pressure check valve to connect in fluid communication with the pressurizable tire cavity and the second port.

18. The method as defined in claim 17 wherein the pneumatic control valve is to be fixedly attached to the tire and at least a portion of the pneumatic control valve is to be disposed within the pressurizable tire cavity.

19. The method as defined in claim 17 wherein the set point valve comprises:
a cylinder;
a cylinder head disposed in sealing engagement with an end of the cylinder;
an annular poppet valve seat defining an orifice in a conduit in fluid connection with the inlet;
a poppet valve having a poppet disposed at an end of a substantially cylindrical valve stem and having an actuator flange disposed on the valve stem opposite to the poppet, wherein the poppet is selectively sealingly engageable with the poppet valve seat; and
a resilient diaphragm operatively disposed in sealing engagement with the cylinder head, the diaphragm to sealingly separate a cylinder volume from the pressurizable tire cavity and to apply a closing force on the valve stem in response to a pressure difference between a cylinder pressure and a tire pressure in the pressurizable tire cavity.

20. The method as defined in claim 19 wherein the set point valve further comprises:
an annular valve stem guide including a barrel defining a bore and an annular spring retention flange disposed at a spring end of the barrel, the valve stem guide disposed in the cylinder and slidingly engaged with the valve stem guide in the bore, the valve stem guide including a fluid conduit to equalize pressure between the manifold and the cylinder; and
a biasing spring disposed between the spring retention flange and the actuator flange to urge the poppet valve open with a biasing preload, wherein the biasing preload corresponds to a set point pressure, the poppet to sealingly engage the poppet valve seat if the tire air pressure is greater than or equal to the set point pressure.

21. The method as defined in claim 20 wherein the biasing preload is selectable to select the set point pressure.

22. The method as defined in claim 19 wherein a seat effective area of the orifice defined by the annular poppet valve seat is substantially equal to a diaphragm effective area of the diaphragm to compensate for a change in the cylinder pressure from vacuum generated by the peristaltic pump when the pneumatic control valve is in a pressure hold mode.

23. The method as defined in claim 20 wherein the set point valve further comprises a set point adjustment screw threadingly engaged with the valve body to operatively engage the spring retention flange to selectively adjust the biasing preload.

24. The method as defined in claim 20 wherein the set point valve further comprises:
a locking flange circumscribing an external surface of the cylinder; and
a locking collar having a plurality of adjustment slots to selectively engage the locking flange to retain the cylinder in one of a plurality of adjustment positions to select the biasing preload and the corresponding set point pressure, wherein the locking flange is visible through a window in the locking collar.

25. The method as defined in claim 17 wherein the clockwise rotation pump feed check valve and the counter-clockwise rotation pump feed check valve each comprise:
a check valve bore defined in the valve body, the check valve bore in fluid communication with the manifold and the respective first port or second port;
a ball valve seat defined at a pump port end of the check valve bore, the ball valve seat circumscribing the respective first port or second port; and
a pump feed check valve ball operatively disposed in the check valve bore, the pump feed check valve ball to operatively engage the ball valve seat to substantially prevent fluid flow from the respective first port or second port to the manifold and to open the respective first port or second port for flow from the manifold to the respective first or second port.

26. The method as defined in claim 17 wherein a respective translatable member of each pump feed check valve is to translate substantially parallel to an axle axis associated with the tire.

27. The method as defined in claim 17 wherein the first tire pressure check valve and the second tire pressure check valve each comprise:
a tire pressure check valve bore defined in the valve body, the tire pressure check valve bore in fluid communication with the pressurizable tire cavity and the respective first or second port;
a check valve seat defined at a pump port end of the tire pressure check valve bore, the check valve seat circumscribing the respective first or second port; and
a tire pressure check valve ball operatively disposed in the tire pressure check valve bore, the tire pressure check valve ball to operatively engage the check valve seat to substantially prevent fluid flow from the pressurizable tire cavity to the respective first or second port and to open the respective first or second tire pressure check valve for fluid flow from the respective first or second port to the pressurizable tire cavity.
